(19) United States
(12) Patent Application Publication
(10) Pub. No.: US 2022/0221094 A1
(43) Pub. Date: Jul. 14, 2022

(54) TUBE FITTING AND TUBE FITTING SET

(71) Applicant: SANOH INDUSTRIAL CO., LTD., Tokyo (JP)

(72) Inventor: Akihiko Horie, Ibaraki (JP)

(21) Appl. No.: 17/612,819

(22) PCT Filed: Feb. 10, 2020
(86) PCT No.: PCT/JP2020/005174

§ 371 Date: Nov. 19, 2021

(30) Foreign Application Priority Data
Jun. 20, 2019 (JP) 2019-114625

(51) Int. Cl. F16L 29/00; F16K 15/06

(52) U.S. Cl. CPC F16L 29/007; F16K 15/063

(57) ABSTRACT

A tube fitting and a tube fitting enabling a configuration that limits a through-flow rate of fluid that has passed through a flow aperture opened by a valve unit are obtained. An upstream-side choke hole in an upstream-side choke section limits the through-flow rate of the fluid. In a case in which the fluid flows at a flow rate exceeding the through-flow rate limited by the upstream-side choke hole, the valve unit opens the closed flows aperture in a flow path. A downstream-side choke hole in a downstream-side choke section disposed at a downstream side of the valve unit limits the through-flow rate of fluid that has passed through the flow aperture.

### TECHNICAL FIELD

The present invention relates to a tube fitting and a tube fitting set.

### BACKGROUND ART

In a valve built-in connector (tube fitting) disclosed in Patent Document 1 (Japanese Patent Application Laid-Open (JP-A) No. 2004-116733), a connector housing of the valve built-in connector is integrally configured of a tube connecting section on one axial direction side, a pipe insertion section on another axial direction side, and a valve housing section between the tube connecting section and the pipe insertion section.

The valve housing section is formed with an inner diameter of a sufficient size such that a valve body and a compression coil spring are housed inside the valve housing section. The compression coil spring biases the valve body toward the one axial direction side so as to abut a housing inner face.

### PATENT DOCUMENTS

Patent Document 1: JP-A No. 2004-116733

### SUMMARY OF INVENTION

### Technical Problem

Conventional tube fittings include a choke section formed with a choke hole that limits a through-flow rate of a fluid, and a valve unit that opens a flow aperture in a flow path in a case in which a flow rate exceeds the through-flow rate limited by the choke hole. Note that a flow rate limiting section is not provided at a downstream side of the choke section in a flow direction of the fluid. Such a flow rate limiting section would limit a through-flow rate of fluid that has passed through the flow aperture opened by the valve unit.

An object of the present invention is to obtain a configuration that limits a through-flow rate of fluid that has passed through a flow aperture opened by a valve unit.

### Solution to Problem

A tube fitting according to a first aspect of the present invention includes: a body having a flow path formed inside for a fluid to flow through; an upstream-side choke section located inside the body and formed with an upstream-side choke hole configured to limit a through-flow rate of the fluid; a valve unit configured to open a closed flow aperture in the flow path in a case in which the fluid flows at a flow rate exceeding the through-flow rate limited by the upstream-side choke hole; and a downstream-side choke section disposed at a downstream side of the valve unit in a flow direction of the fluid and formed with a downstream-side choke hole configured to limit a through-flow rate of fluid that has passed through the flow aperture.

In the above configuration, the upstream-side choke hole formed in the upstream-side choke section limits the through-flow rate of fluid flowing into the tube fitting. In a case in which the fluid flows in the tube fitting at a flow rate exceeding the through-flow rate limited by the upstream-side choke hole, the closed flow aperture is opened by the valve unit.

The downstream-side choke hole in the downstream-side choke section disposed at the downstream side of the valve unit in the fluid flow direction limits the through-flow rate of fluid that has passed through the flow aperture opened by the valve unit.

Disposing the downstream-side choke section at the downstream side of the valve unit in the fluid flow direction in this manner enables a configuration that limits the through-flow rate of fluid that has passed through the flow aperture opened by the valve unit to be obtained.

A feature of the above aspect is that a hole diameter of the downstream-side choke hole is larger than a hole diameter of the upstream-side choke hole.

In the above configuration, the hole diameter of the downstream-side choke hole is larger than the hole diameter of the upstream-side choke hole. This enables the fluid through-flow rate to be limited by the upstream-side choke hole in an initial low flow rate region when the fluid starts to flow into the tube fitting, and the fluid through-flow rate to be limited by the downstream-side choke hole in a high flow rate region when the flow rate of fluid flowing into the tube fitting has increased.

A feature of the above aspect is that the downstream-side choke section is disposed at the downstream side of the valve unit in the flow direction and is disposed so as to be visible from outside the body.

In the above configuration, the downstream-side choke section is disposed at the downstream side of the valve unit in the flow direction and is disposed so as to be visible from outside the body. Thus, a check as to whether the correct downstream-side choke section is attached to the body can be performed by looking at the tube fitting from the fluid flow direction downstream side.

A feature of the above aspect is that the valve unit includes a valve body capable of moving in the flow direction, a biasing portion configured to bias the valve body toward an upstream side in the flow direction, a support portion configured to support an end portion at the flow direction downstream side of the biasing portion, and a contact portion overlooking the flow path and configured to contact the valve body biased by the biasing portion. The valve unit is restricted from detaching from the body toward the flow direction downstream side by the downstream-side choke section.

In the above configuration, the valve unit is restricted from detaching from the body toward the flow direction downstream side by the downstream-side choke section. This enables the valve unit to be restricted from detaching from the body toward the fluid flow direction downstream side without employing a dedicated component to restrict the valve unit from detaching from the body.

A tube fitting set according to a fifth aspect of the present invention includes: a tube fitting including a body having a flow path formed inside for a fluid to flow through, an upstream-side choke section located inside the body and formed with an upstream-side choke hole configured to limit a through-flow rate of the fluid, a valve unit configured to open a closed flow aperture in the flow path in a case in which the fluid flows at a flow rate exceeding the through-flow rate limited by the upstream-side choke hole, and a flow rate limiting section disposed at a downstream side of the valve unit in a flow direction of the fluid and configured to limit the through-flow rate of fluid that has passed through the flow aperture; and plural types of downstream-side choke sections each including a wall portion formed with a downstream-side choke hole configured to limit a flow rate of fluid that has passed through the flow aperture, and an outer peripheral portion joined to the wall portion and configured to engage with an inner peripheral face of the body. Each of the downstream-side choke sections has a different through-flow rate limitation performance due to the downstream-side choke hole having a different hole diameter. Each of the plural types of downstream-side choke sections is capable of functioning as the flow rate limiting section.

In the above configuration, each of the plural types of downstream-side choke sections that have a different through-flow rate limitation performance due to having a different hole diameter functions as the flow rate limiting section that limits the through-flow rate of fluid that has passed through the flow aperture. Thus, by assembling the plural types of downstream-side choke sections having different hole diameters to a common body, plural types of tube fittings that each have a different through-flow rate limitation performance can be obtained.

### Advantageous Effects of Invention

The present invention enables a configuration that limits the through-flow rate of fluid that has passed through the flow aperture opened by the valve unit to be obtained.

### BRIEF DESCRIPTION OF DRAWINGS

FIG. 1 is a cross-section illustrating a tube fitting according to an exemplary embodiment of the present invention.

FIG. 2 is a cross-section illustrating a tube fitting according to an exemplary embodiment of the present invention to which a flow of fluid has been added.

FIG. 3 is a cross-section illustrating a tube fitting according to an exemplary embodiment of the present invention to which a flow of fluid has been added.

FIG. 4 is a cross-section illustrating a tube fitting according to an exemplary embodiment of the present invention to which a flow of fluid has been added.

FIG. 5 is an exploded perspective view illustrating an upstream-side choke section, a downstream-side choke section, and so on included in a tube fitting according to an exemplary embodiment of the present invention.

FIG. 6 is an exploded perspective view illustrating a tube fitting according to an exemplary embodiment of the present invention.

FIG. 7 is a diagram illustrating performance of a tube fitting according to an exemplary embodiment of the present invention in the form of a graph.

FIG. 8 is a schematic configuration diagram illustrating a fuel supply system employing a tube fitting according to an exemplary embodiment of the present invention.

FIG. 9 is a cross-section illustrating a tube fitting according to an exemplary embodiment of the present invention.

FIG. 10 is a cross-section illustrating a tube fitting according to an exemplary embodiment of the present invention.

### DESCRIPTION OF EMBODIMENTS

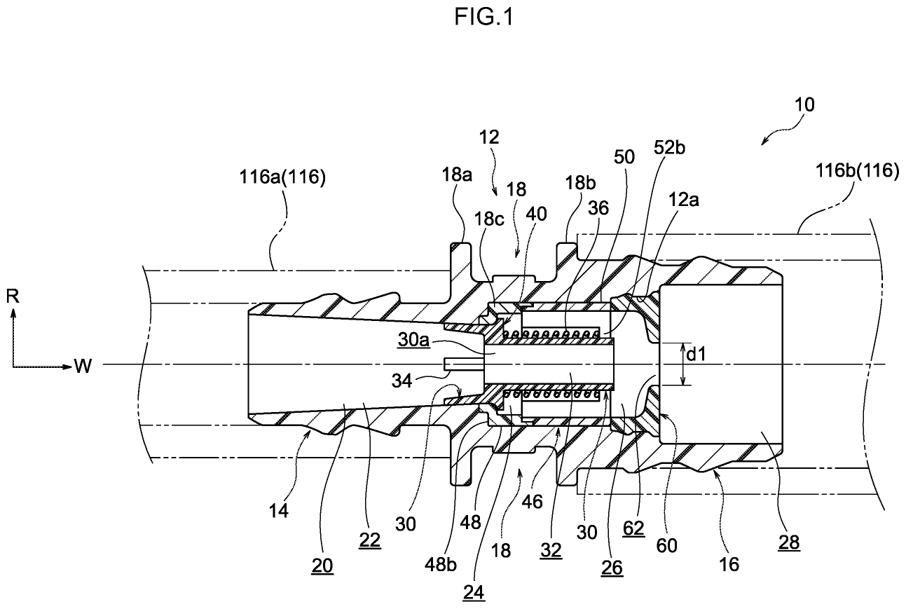

Explanation follows regarding an example of a tube fitting and a tube fitting set according to an exemplary embodiment of the present invention, with reference to FIG. 1 to FIG. 10. Note that in the respective drawings, the arrow R indicates a radial direction of the tube fitting, and the arrow W indicates a length direction of the tube fitting that is also a flow direction of a fuel gas, this being an example of a fluid. First, explanation follows regarding a fuel supply system 100 employing the tube fitting.

Fuel Supply System 100 Employing Tube fitting 10

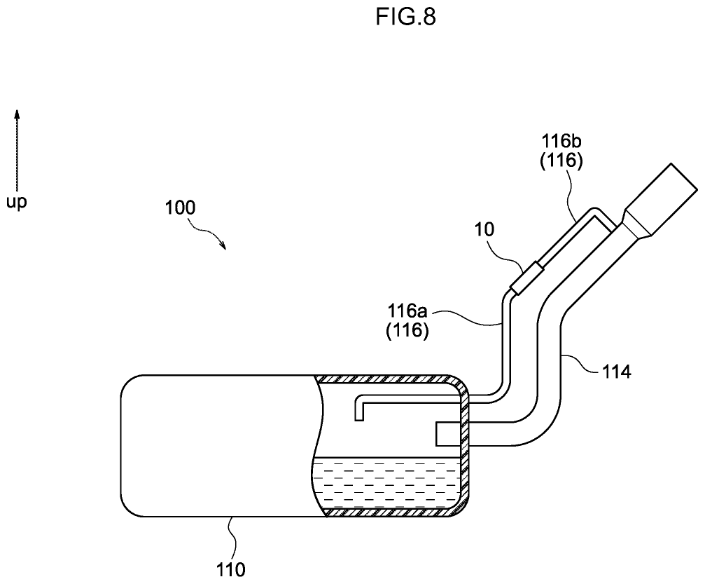

As illustrated in FIG. 8, a tube fitting 10 is employed as part of the fuel supply system 100. The fuel supply system 100 includes a fuel tank 110, a filler pipe 114 for supplying fuel to the fuel tank 110, and a return tube 116 that returns fuel gas, this being a vaporous form of the fuel inside the fuel tank 110, to the filler pipe 114.

The return tube 116 includes a first tube 116a that is connected to the fuel tank 110, and a second tube 116b that is connected to the filler pipe 114. The tube fitting 10 is employed in order to join the first tube 116a and the second tube 116b together. Note that the arrow UP illustrated in FIG. 8 indicates upward with respect to gravitational force.

In this configuration, fuel cannot be supplied to the fuel tank 110 through the filler pipe 114 in a case in which the pressure of the fuel gas inside the fuel tank 110 has risen. Thus, the fuel gas inside the fuel tank 110 is returned from the fuel tank 110 to the filler pipe 114 through the return tube 116. This enables fuel to be supplied to the fuel tank 110 through the filler pipe 114, even in a case in which the pressure of the fuel gas inside the fuel tank 110 has risen.

Note that the tube fitting 10 controls a through-flow rate of fuel gas flowing through the tube fitting 10 so as to control the pressure of the fuel gas inside the fuel tank 110. The configuration by which the tube fitting 10 controls the through-flow rate of fuel gas flowing through the tube fitting 10 is described in detail later.

### Overall Configuration of Tube Fitting 10

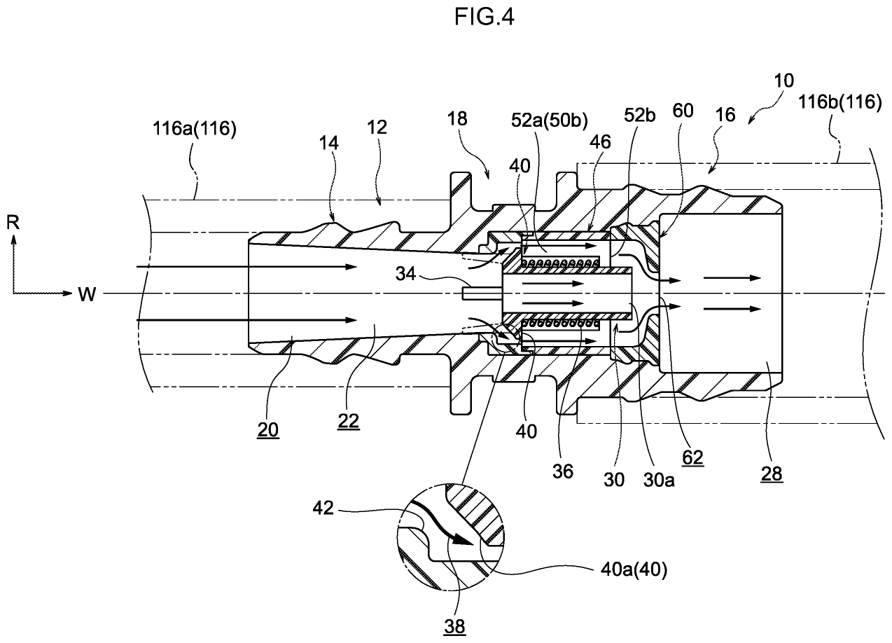

As illustrated in FIG. 1, the tube fitting 10 includes a body 12, an upstream-side choke section 30, a valve body 40, and a biasing spring 36. A flow path 20 that extends along a flow direction (hereafter “gas flow direction) of the fuel gas that is an example of a fluid is formed inside the body 12. An upstream-side choke hole 30a that limits the through-flow rate of flowing fuel gas (hereafter “gas”) is formed in the upstream-side choke section 30. The valve body 40 is capable of moving along the gas flow direction. The biasing spring 36 biases the valve body 40 toward an upstream side in the gas flow direction. The tube fitting 10 also includes a housing section 46 formed with support portions 52b that support the biasing spring 36. The upstream-side choke section 30, the valve body 40, and the biasing spring 36 are housed inside the housing section 46. The tube fitting 10 also includes a downstream-side choke section 60 formed with a downstream-side choke hole 62 that limits the through-flow rate of gas that has passed through a flow aperture 38 (see FIG. 4) that has opened due to the valve body 40 moving toward a downstream side in the gas flow direction.

### Body 12

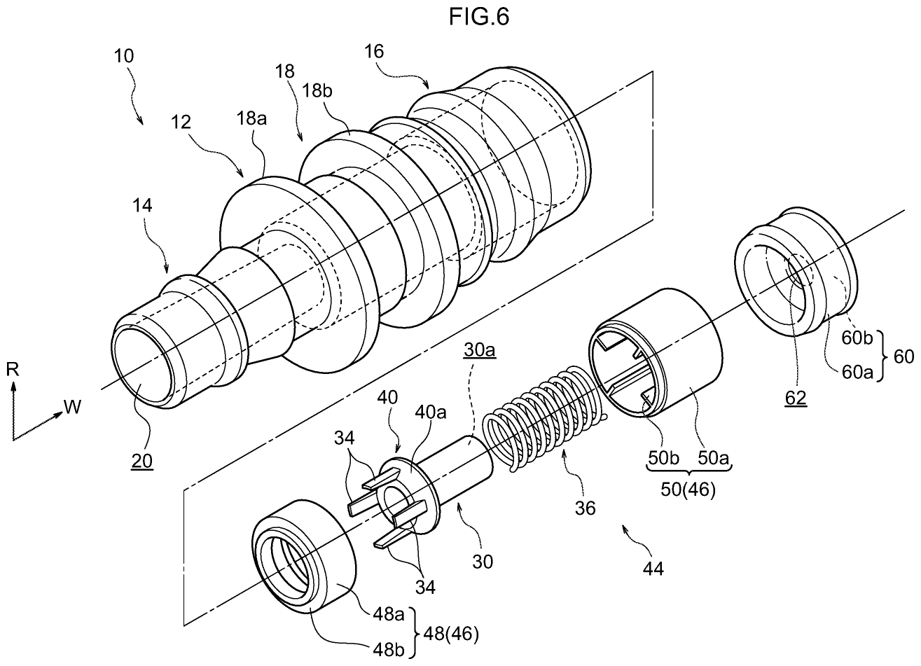

The body 12 is integrally formed of a resin material. As illustrated in FIG. 1 and FIG. 6, the flow path 20 that extends along the gas flow direction is formed inside the body 12. The body 12 includes a first insertion section 14 that is inserted into an end portion of the first tube 116a, a second insertion section 16 that is inserted into an end portion of the second tube 116b, and a coupling section 18 that couples the first insertion section 14 and the second insertion section 16 together. The first insertion section 14, the coupling section 18, and the second insertion section 16 are arrayed in this sequence from the upstream side (the left side in the drawings) to the downstream side (the right side in the drawings) in the gas flow direction.

### First Insertion Section 14, Second Insertion Section 16, and Coupling Section 18

The first insertion section 14 is formed in a circular tube shape extending along the gas flow direction. Ridges (not allocated reference numerals) are formed extending around a circumferential direction at an outer peripheral face of the first insertion section 14 in order to prevent the first tube 116a from coming off.

The second insertion section 16 is formed in a circular tube shape extending along the gas flow direction. Ridges (not allocated reference numerals) are formed extending around a circumferential direction at an outer peripheral face of the second insertion section 16 in order to prevent the second tube 116b from coming off.

The coupling section 18 is formed in a circular tube shape extending along the gas flow direction. A large diameter abutting portion 18a that is abutted by an end of the first tube 116a is formed at a first insertion section 14-side portion of the coupling section 18. A large diameter abutting portion 18b that is abutted by an end of the second tube 116b is formed at a second insertion section 16-side portion of the coupling section 18.

### Flow Path 20

The flow path 20 formed in the body 12 includes a funnel shaped inflow area 22, a first placement area 24 where the housing section 46 is disposed, a second placement area 26 where the downstream-side choke section 60 is disposed, and a circular column shaped outflow area 28, these areas being formed in this sequence from the upstream side to the downstream side in the gas flow direction.

The inflow area 22 is formed in a funnel shape in the first insertion section 14 and part of the coupling section 18, such that a gas flow direction upstream side area has a larger diameter than a gas flow direction downstream side area thereof. Note that a circular tube shaped inflow area with a uniform inner diameter along the gas flow direction may be provided instead of the funnel shaped inflow area 22.

As mentioned previously, the housing section 46 is disposed in the first placement area 24. The first placement area 24 is formed in part of the coupling section 18 and part of the second insertion section 16. The first placement area 24 is formed in a circular column shape having a larger diameter than a small diameter area of the inflow area 22. A stepped face 18c that faces toward the gas flow direction downstream side is formed between the inflow area 22 and the first placement area 24. The stepped face 18c is formed with a step.

As mentioned previously, the downstream-side choke section 60 is disposed in the second placement area 26. The second placement area 26 is formed in part of the second insertion section 16. Ridges (not allocated reference numerals) are formed extending around a circumferential direction at an inner peripheral face 12a of the body 12 where the second placement area 26 is formed in order to prevent the downstream-side choke section 60 from coming off toward the gas flow direction downstream side.

The outflow area 28 is formed in part of the second insertion section 16 in a circular column shape that has a larger diameter than the flow path 20, the first placement area 24, and the second placement area 26.

In this configuration, when assembling the respective components disposed in the flow path 20 to the body 12, these respective components are assembled inside the body 12 from the outflow area 28 side.

### Housing Section 46

As mentioned previously, the housing section 46 is disposed in the first placement area 24 of the flow path 20. As illustrated in FIG. 1 and FIG. 6, the housing section 46 is divided into an upstream housing section 48 at the gas flow direction upstream side, and a downstream housing section 50 at the gas flow direction downstream side.

### Upstream Housing Section 48

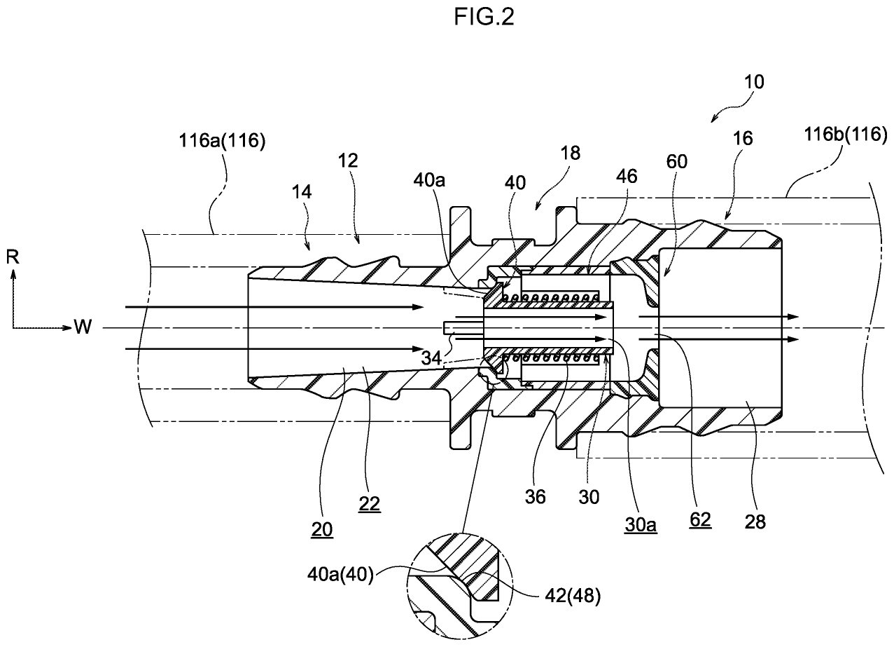

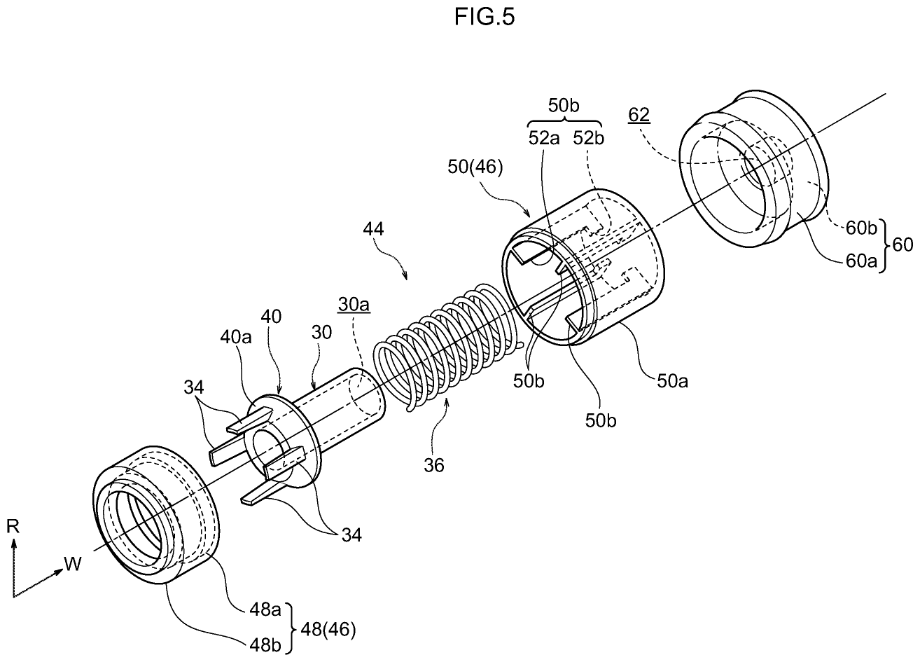

The upstream housing section 48 is integrally formed of a resin material. As illustrated in FIG. 5, the upstream housing section 48 includes a circular tube shaped circular tube portion 48a, and a flange portion 48b formed at the gas flow direction upstream side of the circular tube portion 48a. An outer peripheral face of the circular tube portion 48a contacts the inner peripheral face 12a of the body 12 where the first placement area 24 is formed in a radial direction (hereafter “tube radial direction”) of the tube fitting 10. The flange portion 48b is provided in order to narrow an opening in a gas flow direction upstream side portion of the circular tube portion 48a, and contacts the stepped face 18c of the coupling section 18 in the gas flow direction. The flange portion 48b is formed with a corner portion 42 (see FIG. 2) that overlooks the flow path 20 and contacts a conical face 40a, described later, formed to the valve body 40. The corner portion 42 is an example of a contact portion.

### Downstream Housing Section 50

The downstream housing section 50 is integrally formed of a resin material. As illustrated in FIG. 5, the downstream housing section 50 includes a circular tube shaped circular tube portion 50a, and four ribs 50b that are coupled to an inner peripheral face of the circular tube portion 50a and are arranged at uniform intervals around the circumferential direction of the circular tube portion 50a.

A cross-section profile of the circular tube portion 50a is similar to a cross-section profile of the circular tube portion 48a. A gas flow direction length of the circular tube portion 50a is longer than a gas flow direction length of the circular tube portion 48a. An outer peripheral face of the circular tube portion 50a makes tube radial direction contact with the inner peripheral face 12a of the body 12 where the first placement area 24 is formed.

Plate faces of the ribs 50b face the circumferential direction of the circular tube portion 50a, and each of the ribs 50b has an L shape as viewed along the circumferential direction of the circular tube portion 50a. Each of the ribs 50b includes a base portion 52a extending along the gas flow direction, and the support portion 52b projecting in the tube radial direction from a gas flow direction downstream side portion of the base portion 52a. The support portions 52b support a flow direction downstream side end portion of the biasing spring 36.

In this configuration, a space where the upstream-side choke section 30 and so on are disposed is formed inside the housing section 46 in a state in which the upstream housing section 48 and the downstream housing section 50 have been combined.

### Upstream-Side Choke Section 30, Valve Body 40

The upstream-side choke section 30 and the valve body 40 are integrally formed of a resin material, and are housed inside the housing section 46 as illustrated in FIG. 1 and FIG. 5.

### Upstream-Side Choke Section 30

The upstream-side choke section 30 is formed in a circular tube shape extending along the gas flow direction. The upstream-side choke hole 30a that has a circular cross-section profile is formed inside the upstream-side choke section 30. Note that “choke hole” refers here to a through-hole that has a smaller flow path area than the directly preceding flow path area. For example, the choke hole may be a through-hole having a flow path area that is no greater than 50% of the directly preceding flow path area, such that the through-hole limits the gas through-flow rate.

### Valve Body 40

The valve body 40 is formed in a collar shape at a gas flow direction upstream side portion of the upstream-side choke section 30. The valve body 40 has a circular outer profile as viewed along the gas flow direction. The cone shaped conical face 40a that faces toward the gas flow direction upstream side is formed to the valve body 40.

The valve body 40 further includes guide portions 34 extending toward the gas flow direction upstream side with their respective base end portions coupled to the conical face 40a. The guide portions 34 are arranged at uniform intervals around the circumferential direction of the upstream-side choke section 30. The guide portions 34 make tube radial direction contact with the inner peripheral face 12a of the body 12 where the inflow area 22 is formed so as to guide the upstream-side choke section 30 and the valve body 40 along the gas flow direction. In other words, the upstream-side choke section 30 and the valve body 40 are capable of moving along the gas flow direction as a result of the guide portions 34.

### Biasing Spring 36

The biasing spring 36 is a compression coil spring that is housed inside the housing section 46 and extends along the gas flow direction as illustrated in FIG. 1 and FIG. 5. The circular tube shaped upstream-side choke section 30 is inserted inside the biasing spring 36. The biasing spring 36 is then sandwiched between the support portions 52b and the valve body 40 in the gas flow direction. The biasing spring 36 is an example of a biasing portion.

In this configuration, the biasing spring 36 biases the valve body 40 toward the gas flow direction upstream side, such that the conical face 40a of the valve body 40 is pressed against the corner portion 42 of the upstream housing section 48 and the conical face 40a contacts the corner portion 42 as illustrated in FIG. 2. The flow aperture 38 (see FIG. 4) formed between the corner portion 42 and the conical face 40a is closed in this state.

However, in a case in which the gas flow rate exceeds the through-flow rate limited by the upstream-side choke hole 30a, the biasing spring 36 compresses under gas pressure transmitted to the biasing spring 36 through the valve body 40. As illustrated in FIG. 4, when the biasing spring 36 compresses, the valve body 40 that is being pressed by the flowing gas moves toward the gas flow direction downstream side, and stops on contacting gas flow direction upstream ends of the base portions 52a of the ribs 50b. The conical face 40a of the valve body 40 moves apart from the corner portion 42 as a result, thereby opening the flow aperture 38 such that gas flows through.

In this manner, a valve unit 44 that opens and closes the flow aperture 38 is configured including the valve body 40 that is capable of moving in the gas flow direction, the biasing spring 36 that biases the valve body 40 toward the gas flow direction upstream side, the support portions 52b that support an end portion of the biasing spring 36, and the corner portion 42 that contacts the conical face 40a of the valve body 40 biased by the biasing spring 36.

### Downstream-Side Choke Section 60

The downstream-side choke section 60 is integrally formed of a resin material, and is disposed at the downstream side of the valve unit 44 and is disposed so as to be visible from outside the body 12, as illustrated in FIG. 1 and FIG. 5.

The downstream-side choke section 60 includes a circular tube shaped outer peripheral portion 60a that engages with the inner peripheral face 12a of the body 12, and a wall portion 60b formed with the downstream-side choke hole 62. A gas flow direction upstream side portion of the outer peripheral portion 60a of the downstream-side choke section 60 contacts the housing section 46 in the gas flow direction.

Ridges (not allocated reference numerals) that engage with the inner peripheral face 12a of the body 12 are formed extending around the circumferential direction of the outer peripheral portion 60a. The wall portion 60b extends outward in a radial direction so as to be joined to the outer peripheral portion 60a. The wall portion 60b is formed with the downstream-side choke hole 62 that has a circular profile as viewed along the gas flow direction. A hole diameter of the downstream-side choke hole 62 is larger than a hole diameter of the upstream-side choke hole 30a formed in the upstream-side choke section 30.

In this configuration, the downstream-side choke hole 62 limits the through-flow rate of gas that has passed through the flow aperture 38 opened by the valve unit 44. The downstream-side choke section 60 thereby functions as a flow rate limiting section that limits the through-flow rate of gas that has passed through the flow aperture 38 opened by the valve unit 44. The valve unit 44 is also restricted from detaching from the body 12 toward the gas flow direction downstream side by the downstream-side choke section 60.

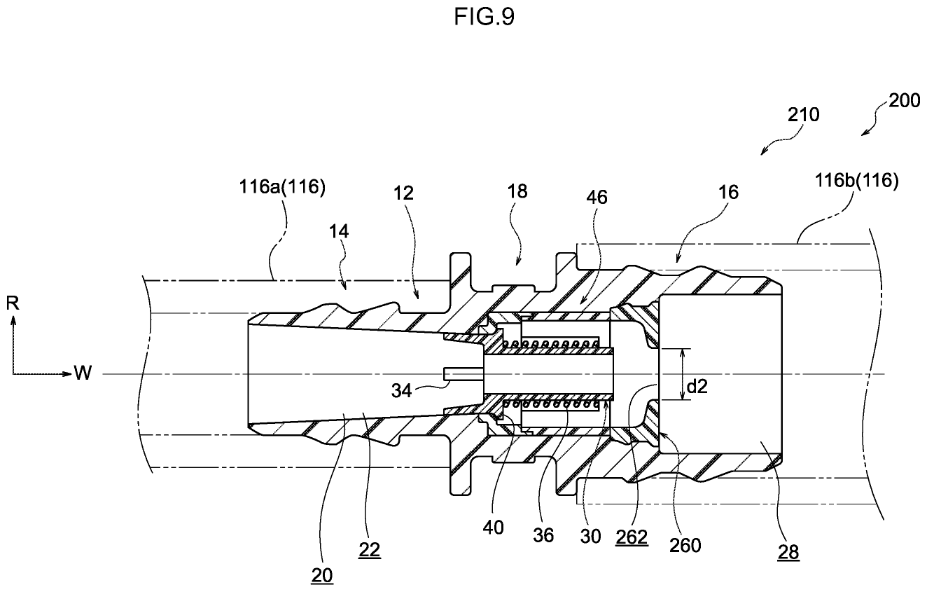

By configuring the downstream-side choke section 60 as a separate body to the body 12, a downstream-side choke section 260 having a different through-flow rate limitation performance than the downstream-side choke section 60 simply due to having a larger hole diameter can be attached to the body 12 (see FIG. 9). Namely, the downstream-side choke section 260 is formed with a downstream-side choke hole 262 that has a larger hole diameter d2 than a hole diameter d1 of the downstream-side choke hole 62 in the downstream-side choke section 60. In such a case, a tube fitting 210 configured by attaching the downstream-side choke section 260 illustrated in FIG. 9 has a different through-flow rate limitation performance than the tube fitting 10.

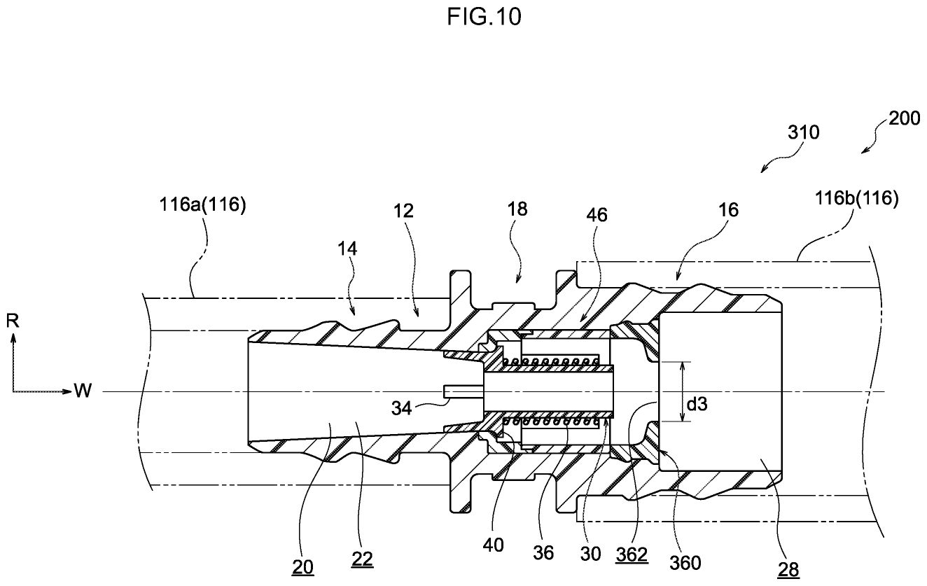

Furthermore, a downstream-side choke section 360 having a different through-flow rate limitation performance than the downstream-side choke sections 60, 260 simply due to having a larger hole diameter can be attached to the body 12 (see FIG. 10). Namely, the downstream-side choke section 360 is formed with a downstream-side choke hole 362 that has a larger hole diameter d3 than the hole diameter d2 of the downstream-side choke hole 262 in the downstream-side choke section 260. In such a case, a tube fitting 310 configured by attaching the downstream-side choke section 360 illustrated in FIG. 10 has a different through-flow rate limitation performance than the tube fittings 10, 210.

Configuring the downstream-side choke sections 60, 260, 360 as separate bodies to the body 12 in this manner enables a tube fitting set 200 to be realized including plural types of tube fittings 10, 210, 310 that each have a different through-flow rate limitation performance due to the respective downstream-side choke holes 62, 262, 362 having different hole diameters.

### Operation

In a case in which the flow rate of gas flowing into the tube fitting 10 from the first tube 116a is no greater than the through-flow rate limited by the upstream-side choke hole 30a, the valve body 40 that is being biased by the biasing force of the biasing spring 36 does not move under the pressure of gas flowing into the tube fitting 10, as illustrated in FIG. 2. Contact between the conical face 40a of the valve body 40 and the corner portion 42 of the upstream housing section 48 is thereby maintained, such that the flow aperture 38 remains closed (see FIG. 4). The inflowing gas thereby flows through the inflow area 22, the upstream-side choke hole 30a, the downstream-side choke hole 62, and the outflow area 28 in this sequence (see the arrows in FIG. 2).

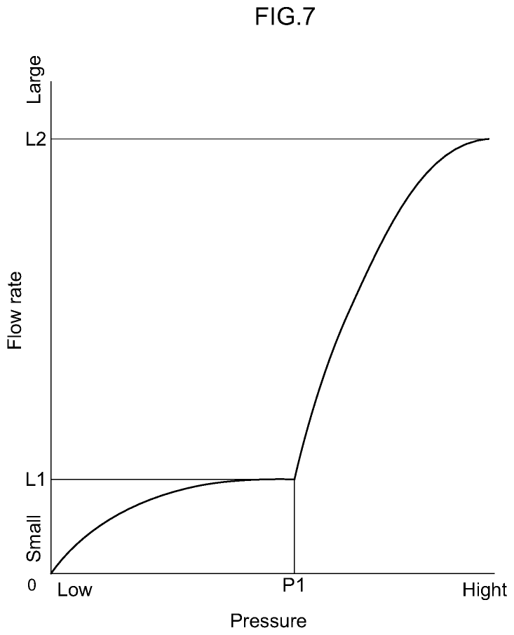

Explanation follows regarding a relationship between the pressure of gas flowing into the tube fitting 10 and the flow rate of gas passing through the tube fitting 10. In the graph illustrated in FIG. 7, the horizontal axis represents the pressure of gas flowing into the tube fitting 10, and the vertical axis represents the flow rate of gas passing through the tube fitting 10. When the pressure is no greater than P1, contact between the conical face 40a of the valve body 40 and the corner portion 42 of the upstream housing section 48 is maintained, and the gas through-flow rate is limited by the upstream-side choke hole 30a. As is evident from this graph, the gas through-flow rate is limited by the upstream-side choke hole 30a while the flow rate of gas passing through the tube fitting 10 is no greater than L1.

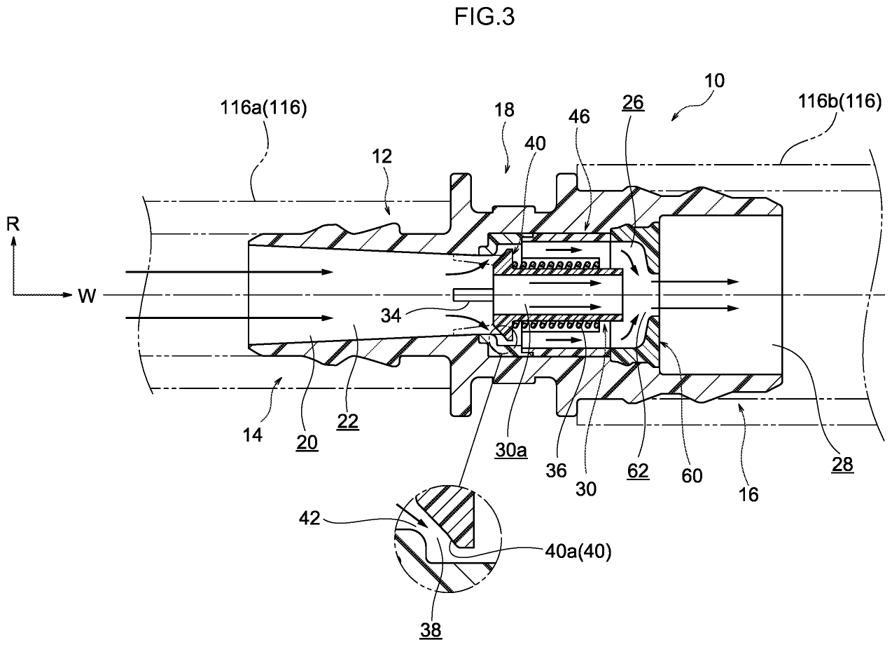

However, when the gas flow rate of gas flowing into the tube fitting 10 from the first tube 116a exceeds the through-flow rate limited by the upstream-side choke hole 30a, the biasing spring 36 compresses under gas pressure transmitted to the biasing spring 36 through the valve body 40, as illustrated in FIG. 3 and FIG. 4. When the biasing spring 36 compresses, the valve body 40 that is being pressed by the flowing gas moves toward the gas flow direction downstream side, and stops on contacting the gas flow direction upstream ends of the base portions 52a of the ribs 50b. The conical face 40a of the valve body 40 moves apart from the corner portion 42 as a result, thereby opening the flow aperture 38 such that gas flows through.

In this manner, gas having a flow rate that has exceeded the through-flow rate limited by the upstream-side choke hole 30a flows along the inflow area 22, the upstream-side choke hole 30a and flow aperture 38, the downstream-side choke hole 62, and the outflow area 28 in this sequence (see the arrows in FIG. 3 and FIG. 4).

The gas through-flow rate is limited to no greater than a flow rate L2 illustrated in the graph in FIG. 7 by the downstream-side choke hole 62 that has a larger hole diameter than the hole diameter of the upstream-side choke hole 30a. As is evident from this graph, the gas through-flow rate is limited by the downstream-side choke hole 62 in a range in which the flow rate of gas passing through the tube fitting 10 exceeds L1 but is no greater than L2.

By making the hole diameter of the downstream-side choke hole 62 larger than the hole diameter of the upstream-side choke hole 30a in this manner, the through-flow rate is limited by the upstream-side choke hole 30a in a low flow rate region, and the through-flow rate is limited by the downstream-side choke hole 62 in a high flow rate region.

### SUMMARY

As described above, by providing the downstream-side choke hole 62 at the gas flow direction downstream side of the upstream-side choke hole 30a, the through-flow rate of gas that has passed through the flow aperture 38 opened by the valve unit 44 can be limited.

Moreover, configuring the downstream-side choke section 60 formed with the downstream-side choke hole 62 as a separate body to the body 12 enables plural types of tube fittings that each have a different performance with respect to limiting the gas through-flow rate in the high flow rate region to be prepared by preparing plural types of downstream-side choke sections which only differ in the hole diameter of their respective downstream-side choke holes.

Moreover, the hole diameter of the downstream-side choke hole 62 is larger than the hole diameter of the upstream-side choke hole 30a. This enables the gas through-flow rate to be limited by the upstream-side choke hole 30a in the initial low flow rate region when gas starts to flow into the tube fitting 10, and the gas through-flow rate to be limited by the downstream-side choke hole 62 in the high flow rate region when the flow rate of gas flowing into the tube fitting 10 has increased.

Moreover, the downstream-side choke section 60 is disposed at the downstream side of the valve unit 44 in the gas flow direction, and is disposed so as to be visible from outside the body 12. Thus, for example, in a case in which plural types of downstream-side choke sections each differing only in the hole diameter of their respective downstream-side choke holes are available, a check for mistaken assembly of a downstream-side choke section can be performed by looking at the tube fitting 10 from the gas flow direction downstream side. In other words, a check as to whether the correct downstream-side choke section is attached can be performed by looking at the tube fitting 10 from the gas flow direction downstream side.

Moreover, the valve unit 44 is restricted from detaching from the body 12 toward the gas flow direction downstream side by the downstream-side choke section 60. This enables the valve unit 44 to be restricted from detaching from the body 12 toward the gas flow direction downstream side by the downstream-side choke section 60 without employing a dedicated component to restrict the valve unit 44 from detaching from the body 12.

Moreover, configuring the downstream-side choke sections 60, 260, 360 as separate bodies to the body 12 enables the tube fitting set 200 to be obtained including the plural types of tube fittings 10, 210, 310 that each have a different through-flow rate limitation performance due to the respective downstream-side choke holes 62, 262, 362 having different hole diameters. In other words, assembling the plural types of downstream-side choke sections 60, 260, 360 each having a different hole diameter to a common body 12 enables the tube fitting set 200 to be obtained including the plural types of tube fittings 10, 210, 310 that each have a different through-flow rate limitation performance. In other words, configuring the downstream-side choke sections 60, 260, 360 as separate bodies to the body 12 enables one tube fitting to be selected from out of the plural types of tube fittings 10, 210, 310 based on the required through-flow rate limitation performance.

Note that although a specific exemplary embodiment of the present invention has been described in detail, the present invention is not limited to this exemplary embodiment, and it would be clear to a person skilled in the art that various other exemplary embodiments may be implemented within the range of the present invention. For example, although the upstream-side choke section 30 and the valve body 40 are integrally formed in the above exemplary embodiment, they may be configured as separate bodies.

Moreover, although one upstream-side choke hole 30a is formed in the upstream-side choke section 30 in the above exemplary embodiment, plural holes may be formed therein. Similarly, although one downstream-side choke hole 62 is formed in the downstream-side choke section 60, plural holes may be formed therein.

Moreover, although gas is employed as an example of a fluid in the above exemplary embodiment, either a liquid or a gas may be employed, as long as it is a fluid.

Moreover, although not described in the above exemplary embodiment, the plural types of downstream-side choke sections 60, 260, 360 may each have a different color. This enables the downstream-side choke section that is attached to the body 12 to be easily identified from the outside.

Moreover, although the tube fitting set 200 includes the three types of tube fittings 10, 210, 310 in the above exemplary embodiment, two types, or four or more types, of tube fittings may be included.

### EXPLANATION OF REFERENCE NUMERALS

10 tube fitting
12 body
20 flow path
30 upstream-side choke section
30a upstream-side choke hole
36 biasing spring (example of biasing portion)
38 flow aperture
40 valve body
42 corner portion (example of contact portion)
44 valve unit
52b support portion
60 downstream-side choke section
60a outer peripheral portion
60b wall portion
200 downstream-side choke hole
200 tube fitting set
210 tube fitting
260 downstream-side choke section
262 downstream-side choke hole
310 tube fitting
360 downstream-side choke section
362 downstream-side choke hole

1. A tube fitting comprising:
a body having a flow path formed inside for a fluid to flow through;
an upstream-side choke section located inside the body and formed with an upstream-side choke hole configured to limit a through-flow rate of the fluid;
a valve unit configured to open a closed flow aperture in the flow path in a case in which the fluid flows at a flow rate exceeding the through-flow rate limited by the upstream-side choke hole; and
a downstream-side choke section disposed at a downstream side of the valve unit in a flow direction of the fluid and formed with a downstream-side choke hole configured to limit a through-flow rate of fluid that has passed through the flow aperture.

2. The tube fitting of claim 1, wherein a hole diameter of the downstream-side choke hole is larger than a hole diameter of the upstream-side choke hole.

3. The tube fitting of claim 1, wherein the downstream-side choke section is disposed at the downstream side of the valve unit in the flow direction and is disposed so as to be visible from outside the body.

4. The tube fitting of claim 1, wherein:
the valve unit includes
a valve body capable of moving in the flow direction,
a biasing portion configured to bias the valve body toward an upstream side in the flow direction,
a support portion configured to support an end portion at the flow direction downstream side of the biasing portion, and
a contact portion overlooking the flow path and configured to contact the valve body biased by the biasing portion; and
the valve unit is restricted from detaching from the body toward the flow direction downstream side by the downstream-side choke section.

5. A tube fitting set comprising:
a tube fitting including
a body having a flow path formed inside for a fluid to flow through,
an upstream-side choke section located inside the body and formed with an upstream-side choke hole configured to limit a through-flow rate of the fluid,
a valve unit configured to open a closed flow aperture in the flow path in a case in which the fluid flows at a flow rate exceeding the through-flow rate limited by the upstream-side choke hole, and
a flow rate limiting section disposed at a downstream side of the valve unit in a flow direction of the fluid and configured to limit a through-flow rate of fluid that has passed through the flow aperture; and
a plurality of types of downstream-side choke sections each including a wall portion formed with a downstream-side choke hole configured to limit a flow rate of fluid that has passed through the flow aperture, and an outer peripheral portion joined to the wall portion and configured to engage with an inner peripheral face of the body, and each of the downstream-side choke sections having a different through-flow rate limitation performance due to the downstream-side choke hole having a different hole diameter,
each of the plurality of types of downstream-side choke sections being capable of functioning as the flow rate limiting section.
